(19) United States
(12) Patent Application Publication
(10) Pub. No.: US 2017/0303648 A1
(43) Pub. Date: Oct. 26, 2017

(54) WALKER-CANE COMBINATION

(71) Applicant: PT Solutions Today, LLC, Dover, DE (US)

(72) Inventors: Jake Ober, Las Vegas, NV (US); Thomas John Travers, Davie, FL (US)

(21) Appl. No.: 15/646,545

(22) Filed: Jul. 11, 2017

Related U.S. Application Data
(63) Continuation-in-part of application No. 15/147,858, filed on May 5, 2016, now Pat. No. 9,723,901.
(60) Provisional application No. 62/365,920, filed on Jul. 22, 2016.
(60) Provisional application No. 62/307,107, filed on Mar. 11, 2016.

(51) Int. Cl. A45B 3/00; A61H 3/00; A61H 3/04; A61H 3/02

(52) U.S. Cl. CPC A45B 3/00; A61H 3/04; A61H 3/00; A61H 2003/0272

(57) ABSTRACT

A self-righting cane is provided that includes a handle portion having a grip and a collar. A shaft extends from the handle portion and is joined to the handle portion at the collar. A base supporting portion includes a weight disposed within the base supporting portion. The weight has an aperture such that the shaft connecting to the base supporting portion through the aperture. The weight disposed within the base supporting portion self-rights the cane and prevents the cane from falling over.

### CROSS-REFERENCE TO RELATED APPLICATION

This application claims priority to U.S. Provisional Application No. 62/365,920 which was filed on Jul. 22, 2016 and is a continuation-in-part of U.S. application Ser. No. 15/147,858 which was filed on May 5, 2016, which application claims priority to U.S. Provisional Application No. 62/307,107 which was filed on Mar. 11, 2016. The contents of each of the above applications is incorporated by reference.

### BACKGROUND

The disclosed embodiments relate to physical therapy devices. More specifically, the disclosed embodiments are related to canes, walkers, and/or devices to aid in walking.

Many people have occasion during their lives where personal mobility may become difficult. For example, injury, disease, accidents, old age, or other situations may arise where a person finds it more difficult to walk around unassisted. To help in such situations, walkers, canes, and crutches are used to help a person retain his or her mobility.

As a person uses a cane or crutches to move about, he or she often needs to temporarily store the cane or crutches to complete a separate task, to sit down, or the like. Typically, the person will attempt to store the cane or crutches in an upright position. For example, the person may lean the cane or crutches against a wall or furniture. Sometimes, despite the person's best efforts, the cane or crutches fall over. For a person with limited mobility, it can be very difficult to retrieve the cane or crutches.

For example, it has been observed that almost half of all patients having gone to an outpatient musculoskeletal clinic do so because of lumbar spine pain, a condition in the spinal column of L1-L5. Indeed, the prevalence of low back pain is increasing. For such people with limited mobility, it may be very difficult and/or painful to retrieve canes or crutches that have fallen over.

When a cane is not easily accessible, for example, because it has fallen over or is located against a wall or furniture away from the user, the chance for falling increases. According to a WHO global risk fall report, approximately 28-35% of people aged of 65 and over fall each year, increasing to 32-42% for those over 70 years of age.

Further, when the elderly bend over and naturally flex the lumbar spine, they put themselves in a position where they are prone for a herniation, or to increase the pain of an already increasing herniation, or to increase the pain from foraminal stenosis. Thus, situations where canes or crutches end up of the floor should be avoided.

Walkers are used as an ambulation aid and are considered a four-point ambulation aid. This type of ambulation restricts the natural biomechanical motion of the gait of the patient, therefore not aiding in rehabilitation or in regaining the strength of the patient to progress towards independent mobility. With this said, a walker (4-point ambulation) is needed for many patients, especially those who do not have the biomechanical ability and/or confidence in specific settings to ambulate around obstacles and/or people in any environmental setting. However, for many of these patients, when they get home, they confidently move around with only a cane (single point ambulation), which facilitates natural biomechanical motion and helps significantly in regaining mobility. It has been found that it is important to help patients progress from four-point ambulation to single-point ambulation to aid in rehabilitation.

### SUMMARY

Given the above, there is a need for a cane or crutches that may be easily accessible even when temporarily stored during a period of non-use. Accordingly, in one embodiment, a self-righting cane is provided that includes a handle portion having a grip and a collar. A shaft extends from the handle portion and is joined to the handle portion at the collar. A base supporting portion includes a weight disposed within the base supporting portion. The weight has an aperture such that the shaft connecting to the base supporting portion through the aperture. The weight disposed within the base supporting portion self-rights the cane and prevents the cane from falling over.

In further embodiments, the base supporting portion further may comprise a ferrule collar. The ferrule collar is disposed so as to cover the weight and surround the shaft. The ferrule collar may be hollow. It may also be configured with a rounded conical shape.

In some embodiments, a width of the base supporting portion is at least twice that of a width of the shaft in order to provide added stability. In other embodiments, the width may be at least three times the width of the shaft. The base supporting portion may be formed in a circular shape. The base supporting portion may have a diameter from two to six inches. The weight within the base supporting portion may be disc shaped. The base supporting portion may also comprise an annular channel surrounding the weight. In some instances, the length of the shaft is extendable.

According to another embodiment, a base supporting portion for self-righting a cane, crutch, or staff is provided. The base supporting portion includes a bottom surface, an internal space configured with a weight disposed therein, and a ferrule collar for connecting to the cane, crutch, or staff. The ferrule collar may be disposed so as to cover the weight and surround a shaft of the cane, crutch, or staff. The ferrule collar is hollow and may have a rounded conical shape.

A width of the base supporting portion may be at least twice that of a width of a shaft of the cane, crutch, or staff. In some instances, the base supporting portion comprises a circular shape. A diameter of the base supporting portion may be between two and six inches. The weight may disc shaped to fit within the circular base supporting portion. The base supporting portion may also comprise an annular channel surrounding the weight. An external layer may be disposed on the bottom surface of the base supporting portion so as to cover and protect the bottom surface.

In another embodiment, a walker is provided where on one or both sides of the walker, a cane may detach from clips or other attaching devices. This allows the cane to be used at home and provide the patient with a more biomechanical gait pattern (single point gait), therefore facilitating more independence, which in return can facilitate more confidence.

Many advantages may be gained from the embodiments to allow patients to go from one ambulation aid to the other at any time in which they so choose. By doing so, the progression towards single point ambulation and independent mobility may be enhanced.

### BRIEF DESCRIPTION OF THE DRAWINGS

FIG. 1 is a perspective view of a self-righting cane, according to one exemplary embodiment.

FIG. 2 is a perspective view of a base of a self-righting cane, according to one exemplary embodiment.

FIG. 3 is another perspective view of a base of a self-righting cane, according to one exemplary embodiment.

FIG. 4 is an exploded view of a base of a self-righting cane, according to one exemplary embodiment.

FIG. 5 is a perspective view of a ferrule collar, according to one exemplary embodiment.

FIG. 6 is a perspective view of a base support for a self-righting cane, according to one exemplary embodiment.

FIG. 7 is a perspective view of a walker with a removable cane, according to one exemplary embodiment.

FIG. 8 is a rear perspective view of a walker with a removable self-righting cane, according to one exemplary embodiment.

FIG. 9A is an attachment pieces for a walker with a removeable cane, FIG. 9B is an exploded view of walker, cane, and attachment piece, and FIG. 9C shows an attachment of a cane to a walker, according to one exemplary embodiment.

The components in the figures are not necessarily to scale, emphasis instead being placed upon illustrating the principles of the invention. In the figures, like reference numerals designate corresponding parts throughout the different views.

### DETAILED DESCRIPTION OF EMBODIMENTS

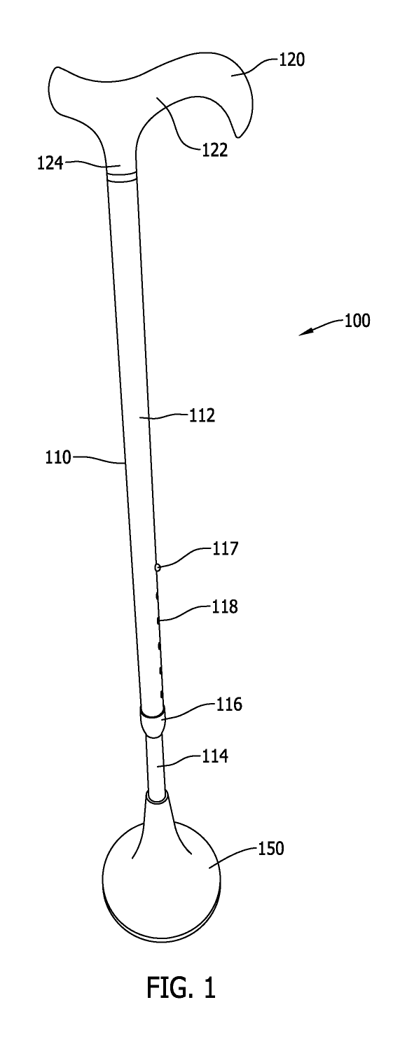

FIG. 1 is a perspective view of a self-righting cane, according to one exemplary embodiment. In FIG. 1, there is a cane 100 having a shaft 110, handle portion 120, and a base 150. The cane 100 is merely exemplary, and any number of other designs or styles of canes may be used. Further, other walking aids are considered to be within the scope of the disclosure, such as crutches, staffs, or the like.

The handle portion 120 includes a grip 122 which a user may grasp to hold onto the cane 100 while walking. A collar 124 is also provided at a lower end of the handle portion 120. The collar 124 is configured to attach to the shaft 110. The handle portion may be manufactured from any suitable material such as various plastics, woods, metals, or other natural or synthetic materials. The handle 120 may include an outer coating material to facilitate grip, such as a rubber material in some embodiments. The handle 120 may be constructed to be removable from the shaft 110, or may be permanently affixed thereto.

The shaft 110 comprises an upper shaft 112 and a lower shaft 114 so as to be extendable. In some embodiments, however, the shaft 110 may be a fixed length. The upper shaft 112 may comprise a number of apertures 118. The apertures 118 are configured to receive a biased pin 117 of the lower shaft to lock the lower shaft 114 into one a plurality of positions relative to the upper shaft 112. In this manner, the height of the cane 100 may be adjusted. This, of course, is just one example of a height adjustment, and any other height adjustment technique may be utilized.

The upper shaft 112 may further comprise a lower collar 116 to reinforce the connection between the upper shaft 112 and the lower shaft 114. In some embodiments, the collar 116 may be a locking collar to lock the upper shaft 112 relative to the lower shaft 114 to adjust the height of the shaft 110. The shaft 110 may be constructed of any suitable material including metals such as aluminum, plastics, carbon-fiber, or other natural or synthetic materials.

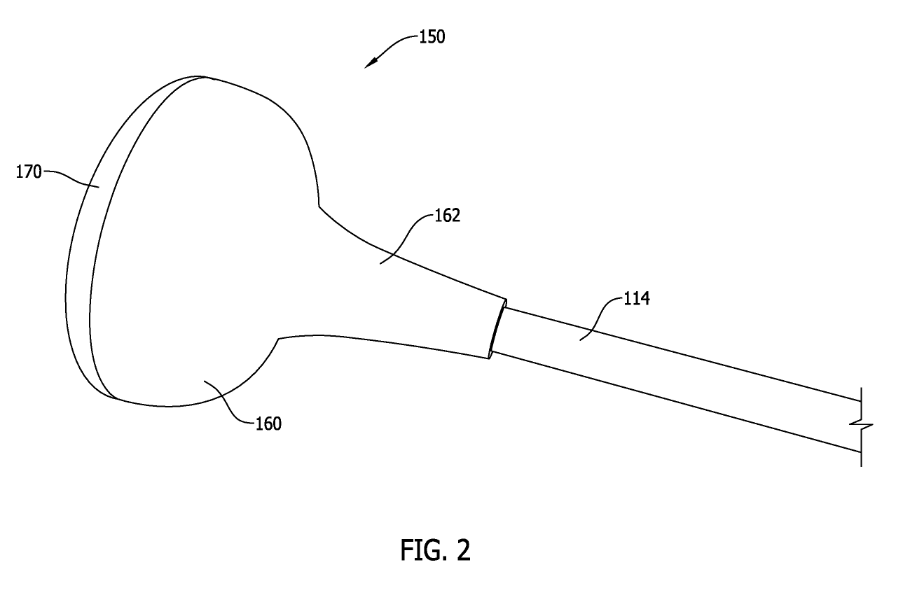

FIG. 2 is a perspective view of a base of a self-righting cane, according to one exemplary embodiment. The base 150 comprises a ferrule collar 160 and a base support 170. The ferrule collar 160 includes a ferrule 162 that attaches to and reinforces the lower shaft 114.

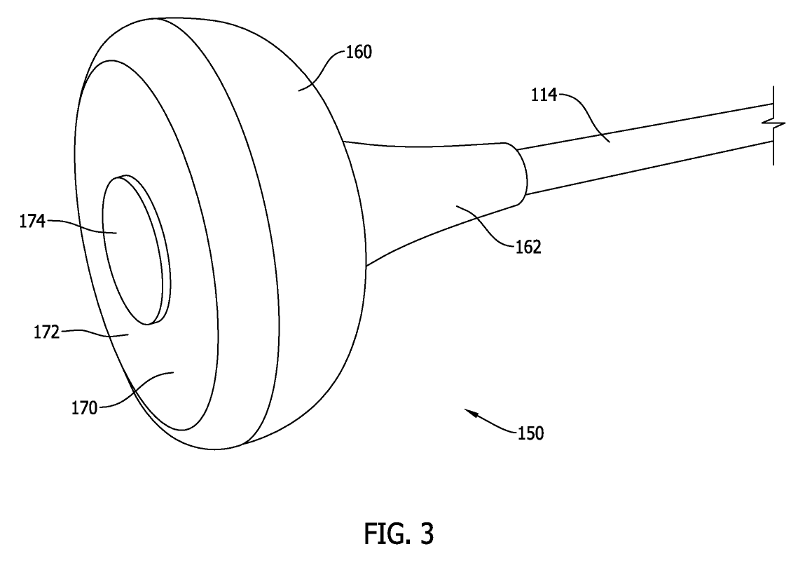

FIG. 3 is another perspective view of a base of a self-righting cane, according to one exemplary embodiment. As shown in FIG. 3, the base support 170 comprises a bottom surface 172 that comes into contact with the ground or other surface. The bottom surface 172 may further comprise an outer layer 174. The outer layer 174 may be overlaid on the bottom surface 172 to provide the surface 172 protection from wear, to reduce noise during use, and/or to dampen the impact when the surface 172 comes into contact with the ground.

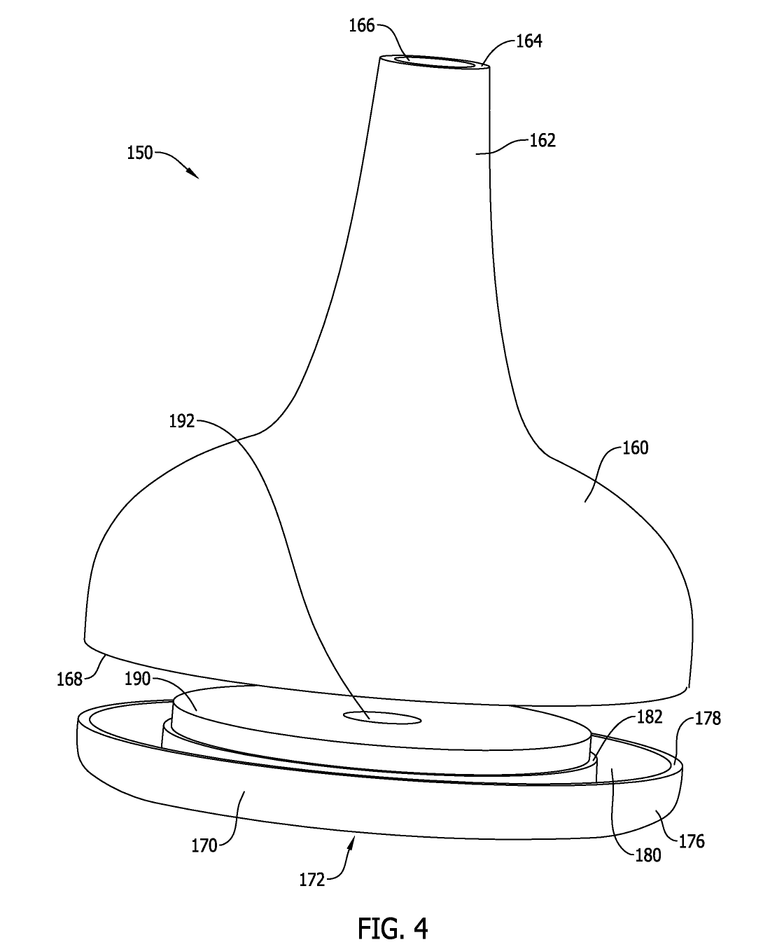

FIG. 4 is an exploded view of a base of a self-righting cane, according to one exemplary embodiment. As shown in FIG. 4, ferrule 162 of the collar 160 comprises a top surface 164. The top surface 164 includes an aperture 166 through which the shaft 110 extends. The collar 160 further comprises a lower surface 168.

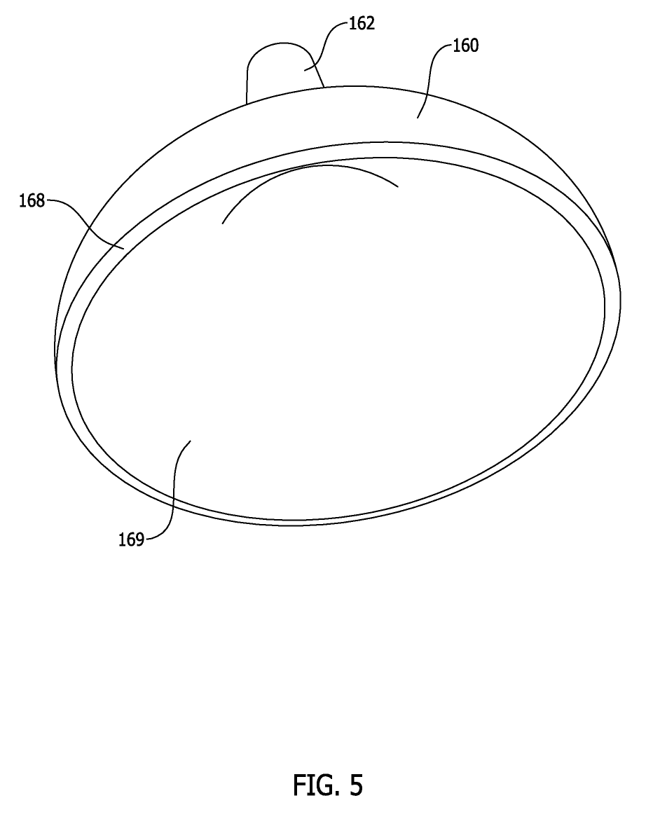

FIG. 5 is a perspective view of a ferrule collar, according to one exemplary embodiment. The collar 160 may also comprise a hollow interior 169. The collar 160 in this embodiment is formed in a rounded cone-like shape. However, the collar 160 may be formed in any suitable shape according to the design preferences of the user. The collar 160 may be manufactured from any suitable light weight material including metals such as aluminum, plastics, carbon-fiber, or other natural or synthetic materials.

Returning to FIG. 4, the base support 170 comprises a bottom surface 172 with a rounded edge 176. The rounded edge 176 facilitates a range of motion for the cane 100 during use and facilitates the self-righting characteristics as will be described in more detail below. The base support 170 further comprises an upper lip 178 that comes into contact with the lower surface 168 of the collar 160. A second lip (annular flange) 182 is provided on a top side of the base support 170 and defines along with the lip 178 an annular hollow space or annular channel 180 within the base 170 and on the top side of the base 170.

A weight 190 is disposed within the second lip 182. The weight 190 thus rests on the bottom of the base support 170. The weight 190 in this embodiment is formed in a disc shape. However, other shapes may also be utilized. The weight 190 comprises an aperture 192 into which the shaft 110 may be inserted.

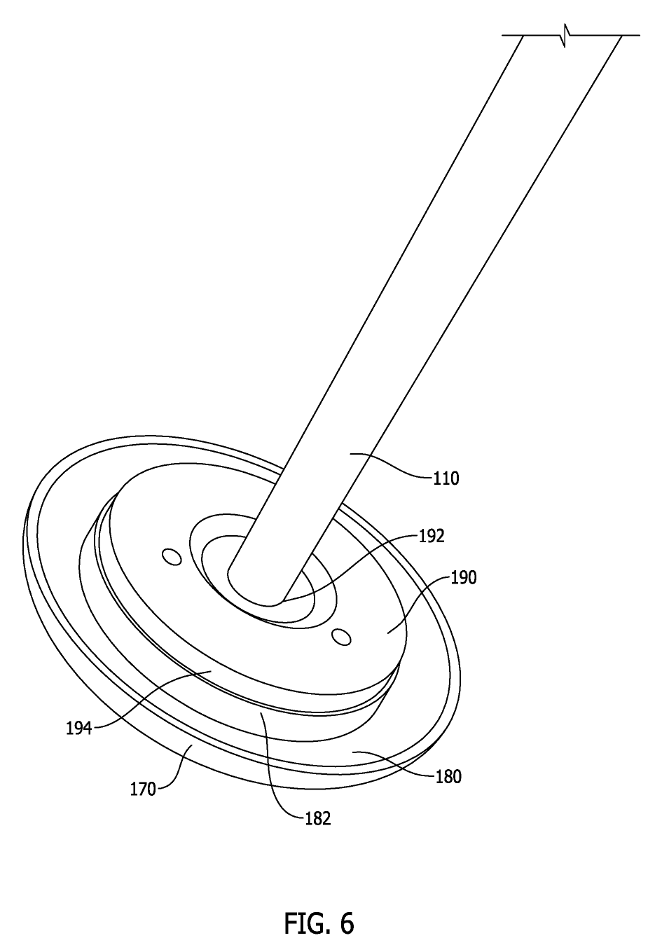

FIG. 6 is a perspective view of a base support for a self-righting cane, according to one exemplary embodiment. As shown in FIG. 6, the shaft 110 may be connected to the base 170 by extending through the aperture 192 of the weight 190. The base portion 170 and weight 190 are formed in a circular shape having a diameter substantially larger than the shaft 110. For example, the diameter of the base portion 170 and weight 190 may be more than twice the diameter of the shaft in some embodiments, or more than three times the diameter of the shaft. With the support 170 having a relatively large diameter and the weight 190 being disposed at the bottom of the cane 100 within the support 170, the cane 100 takes on self-righting characteristics.

Typical canes or crutches have a fairly even weight distribution along the length of the cane or crutch. Because of this, it is difficult to balance the cane or crutch because when the cane or crutch is slightly off-center, the torque produced by the weight of the cane is sufficient to cause the cane to tip and fall. With the base support 170 and weight 190, the shape and the weight distribution of the base support 170 counteract against a torque caused by the handle 120 being off-center. This tends to cause the cane to self-right in a balanced, standing position even when the cane is placed onto a surface without the shaft 10 being placed in an exactly vertical orientation.

The diameter of the support 170 and the weight of the weight 190 may vary based on the amount of self-righting desired. For example, in some embodiments the diameter of the support may range from two inches to six inches. In other embodiments, the diameter of the support may range from three inches to five inches. The weight may be configured from eight ounces to three pounds in some embodiments. In other embodiments, the weight may be configured from one pound to two pounds.

The configuration of the base 170 and weight 190 affect a maximum angle of the shaft 110 from the vertical at which the cane with self-right. In one embodiment, the base 170 and weight 190 are configured such that the cane 100 self-rights when the shaft is as far as 22 degrees or less from the vertical. In other embodiments, the cane 100 self-rights when the shaft is 30 degrees or less from the vertical. In still further embodiments, the cane 100 self-rights when the shaft is 15 degrees or less from the vertical.

Further modifications and additions may be made to the cane 100 or crutches with the self-righting features as described herein. For example, the handle portion of the cane may facilitate any number of add-on devices such as pill cases, insulin pack, blood pressure cuffs, and the like. In some embodiments, the cane may comprise a speaker with a battery as a power source which can be remotely actuated. The speaker may help a person find the cane, such as a person who is visually impaired.

The cane including the handle, shaft, and base support may be configured in any variety of styles and ornamentation to appeal to various user preferences. For example, pictures of favorite sports teams or memories may be included on the cane handle, lightening up the day of a person who much use the cane, such as one who has experienced and accident or who may be elderly.

The self-righting cane may provide a number of advantages. First, the cane may simply be set on the floor and will remain standing until retrieved. This allows the cane to be temporarily stored at any location such that the user can briefly leave the cane while attending to another task. This also prevents the risk of falls, pain associated with bending over, and other similar problems posed by canes incapable of self-righting.

Because the cane is self-righting and easily retrievable by the user, it is possible that a user undergoing therapy to regain mobility may advance to using the cane sooner than other canes. Advancing to single point ambulation is an important milestone for patients progressing to the point of becoming independent from the help of an ambulation aid. Further, any slight increase in the weight of the self-righting cane as compared with other canes (though not substantial enough to affect normal ambulation in any way) may aid in elderly patients recovering from muscular atrophy, again helping the patient to become more independent. Studies also show that the more confident a patient is about their ability to prevent themselves from falling, the less they will actually fall, another advantage of the embodiments.

The ability of the cane to self-right may also aid in the treatment of neurological symptoms. Neurological symptoms caused from musculoskeletal conditions are extremely common in the elderly. Neurological pathologies caused by traumatic brain injuries, spinal cord conditions, strokes, genetic conditions, vestibular pathologies, or any pain/disorder stemming from the brain and spinal cord may be common in any age. The ability for this cane according to the embodiments herein to self-right may aid in the growth of vestibular rehabilitation. This is because a patient may often and naturally track the movement of the cane with the eyes. Such eye tracking may be beneficial in a patient with a condition such as nystagmus.

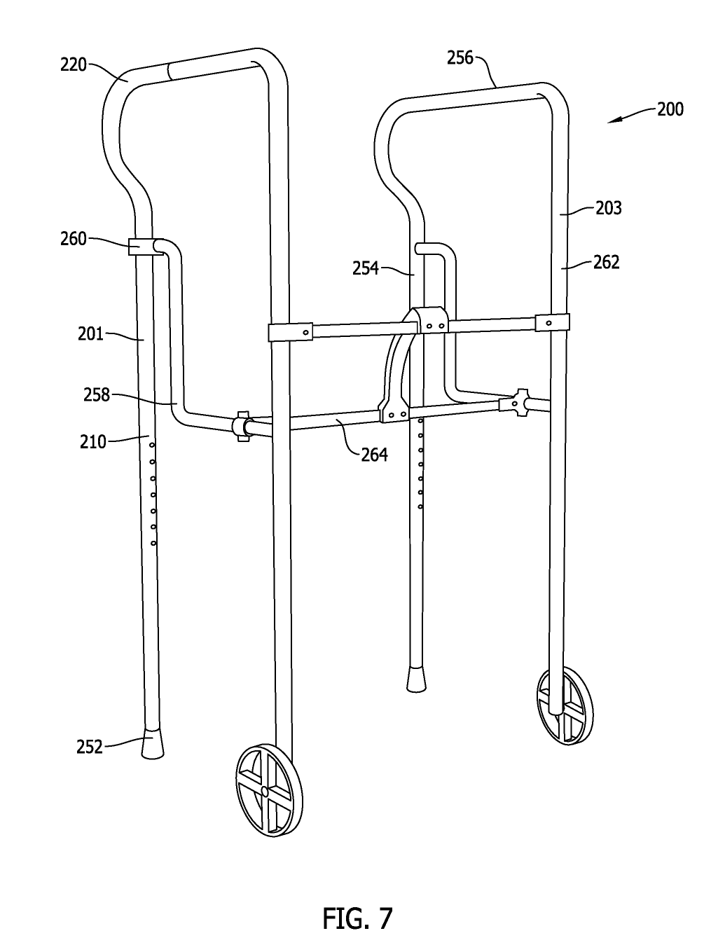

FIG. 7 is a perspective view of a walker with a removable cane, according to one exemplary embodiment. As shown in FIG. 7, a walker-cane combination 200 comprises a cane portion 201 and a walker portion 203. The walker portion 203 comprises handles 256, front legs 262, cross members 264, and wheels 266. In some embodiments, the cross members 264 may be foldable to fold the walker portion 203 when not in use. The walker portion 203 is exemplary, and many other walker designs now known or later-developed may be used.

The walker portion also comprises non-linear members 258 that connect the front legs 262 to the rear leg 254 of the walker portion 203 and the shaft 210 of the cane 201. The non-linear members 258 are formed to provide a high access point for the clip 260 while keeping an overall low center of gravity for the walker portion 203. Thus, the non-linear member 258 attaches to the front legs 262 at a position lower than the clip 260 and the attachment to the rear leg 254. The overall lower center of gravity of the walker portion 203 ensures that the walker portion 203 is stable even when the cane 201 is removed.

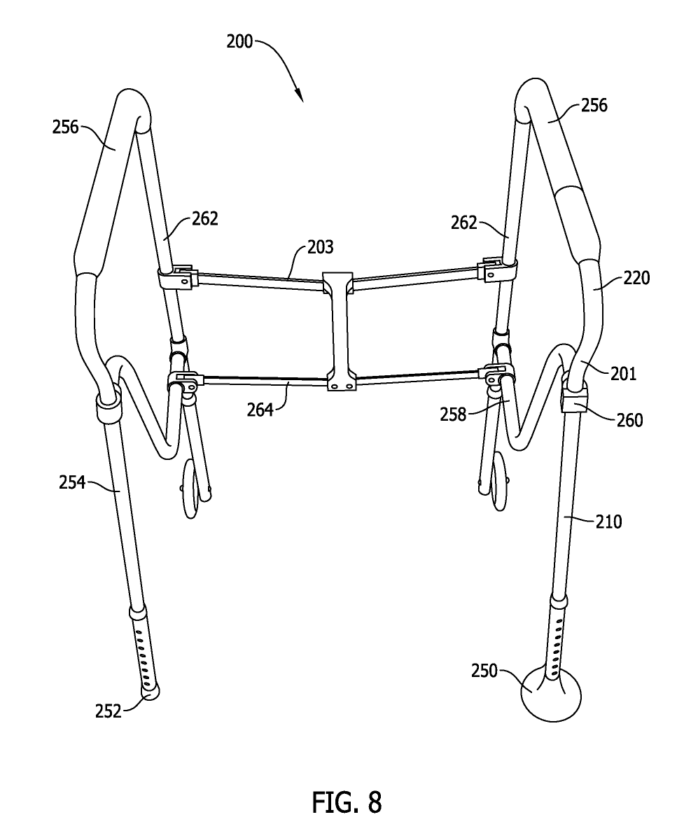

The walker-cane 200 combination allows a user to utilize four-point ambulation while having the option to remove the cane 201 for single-point ambulation in an environment where the user feels more confident, or as the user regains mobility. FIG. 8 is a rear perspective view of a walker with a removable self-righting cane, according to one exemplary embodiment. The removable cane 201 can be a self-righting cane such as the cane 100 described above. As such, the cane 201 may have a self-righting base 250 while the rear leg 254 of the walker portion 203 has a rubber stopper 252. In other embodiments, the rear leg 254 may have a base that is similar to base 250 for aesthetics and balance purposes. In further embodiments, the rear leg 254 may also be a removable cane. The walker may also have one or more kickstands that stabilize the walker when one or both of the canes are removed.

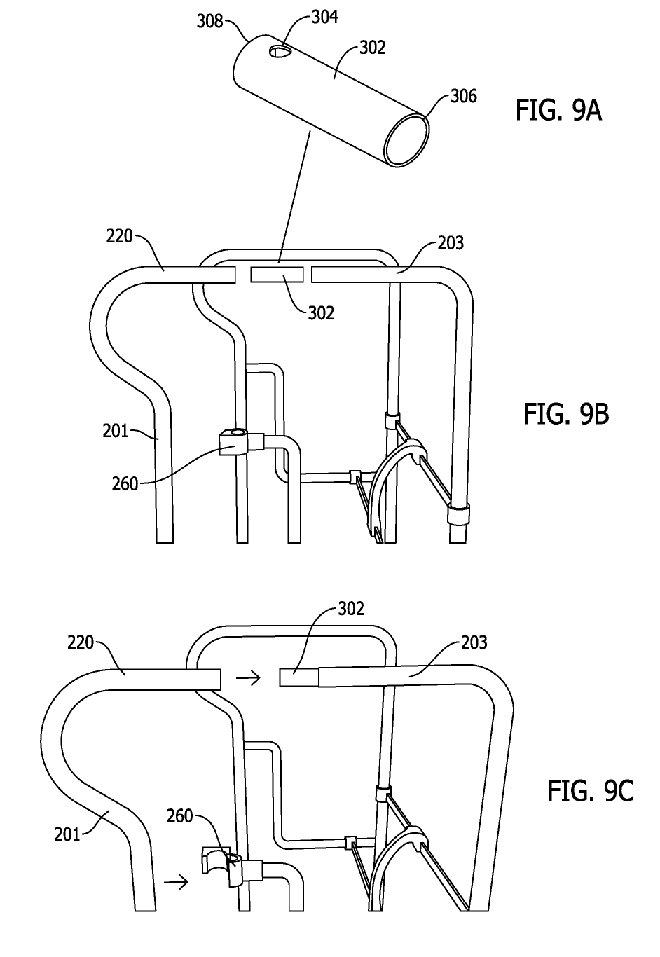

FIG. 9A is an attachment pieces for a walker with a removeable cane. An attachment 302 comprises an aperture 304 that can facilitate a spring loaded connector. The attachment 302 comprises a first end 306 configured to be secured to the walker portion 203 and a second end 308 that is removably attached to the cane 201. FIG. 9B is an exploded view of walker, cane, and attachment piece showing the assembly of the walker portion 203, cane 201, and attachment 302.

FIG. 9C shows an attachment of a cane to a walker, according to one exemplary embodiment. When the cane 201 is removed, the clip 260 is opened and the cane slides off of the attachment 302. To rejoin the cane 201, the cane 201 slides over the attachment 302 and is locked into the clip 260. In some embodiments, the second end 308 of the attachment 302 may be narrowed or comprise a chamfer to facilitate the rejoining of the cane 201 to the walker portion 203.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A walker-cane combination comprising:
a walker portion having front legs and a rear leg, and
a detachable cane that is removably connected to the walker portion and forms a forth leg of the walker portion when attached to the walker portion.

2. The walker-cane combination of claim 1, further comprising foldable cross members connecting the front legs.

3. The walker-cane combination of claim 1, further comprising a first non-linear member connecting a first of the front legs and the rear leg and a second non-linear member connecting a second of the front legs and the detachable cane, wherein the non-linear members connect to the front legs at a position lower than a connection between the non-linear members and the rear leg and the cane.

4. The walker-cane combination of claim 1, wherein the detachable cane comprises a self-righting cane.

5. The walker-cane combination of claim 4, wherein the self-righting cane comprises:
a handle portion including a grip and a collar, the handle portion defining a top side of the self-righting cane;
a shaft extending from the handle portion and joined to the handle portion at the collar; and
a base supporting portion defining a bottom side of the self-righting cane, the base supporting portion comprising
a weight disposed within the base supporting portion, the weight comprising an aperture, and the shaft connecting to the base supporting portion and extending through the aperture, and
a ferrule collar covering the weight and surrounding the shaft, the ferrule collar being formed with a width that narrows from the bottom side towards the top side.

6. The walker-cane combination of claim 4, wherein
the base supporting portion comprises a bottom surface, the bottom surface having a rounded edge extending continuously upwards from the bottom surface to form a lip, the lip being in contact with a lower surface of the ferrule collar, the base supporting portion further comprising an annular flange extending upwards from a top side of the base supporting portion, the weight being disposed on the base supporting portion within the annular flange, and the lip and the annular flange defining an annular channel surrounding the weight on the top side of the base supporting portion.

7. The walker-cane combination of claim 5, wherein the ferrule collar is hollow.

8. The walker-cane combination of claim 5, wherein the ferrule collar has a rounded conical shape.

9. The walker-cane combination of claim 5, wherein a width of the base supporting portion is at least twice that of a width of the shaft.

10. The walker-cane combination of claim 5, wherein the base supporting portion comprises a circular shape.

11. The walker-cane combination of claim 10, wherein a diameter of the base supporting portion is between two and six inches.

12. The walker-cane combination of claim 10, wherein the weight is disc shaped.

13. The walker-cane combination of claim 5, wherein a length of the shaft is extendable.

14. The walker-cane combination of claim 1, wherein a center of gravity of the walker-cane combination allows the walker portion to remain upright on the front legs and the rear leg with the cane detached.

15. The walker-cane combination of claim 1, further comprising an attachment secured to a handle of the walker portion, the cane be configured to removably slide onto the attachment.

16. The walker-cane combination of claim 1, wherein the walker portion comprises a clip configured to releasably attach to the cane.

17. The walker-cane combination of claim 3, wherein the walker portion comprises a clip at the connection between the non-linear member and the cane, wherein the clip releasably attaches to the cane.

18. The walker-cane combination of claim 1, further comprising wheels attached to the front legs.
